(19) United States
(12) Patent Application Publication
(10) Pub. No.: US 2013/0285911 A1
(43) Pub. Date: Oct. 31, 2013

(54) Controlling a computer using a wireless mouse

(71) Applicants: Oluf Nissen, Cupertino, CA (US); Robert Campesi, San Jose, CA (US)

(72) Inventors: Oluf Nissen, Cupertino, CA (US); Robert Campesi, San Jose, CA (US)

(21) Appl. No.: 13/459,375

(22) Filed: Apr. 30, 2012

(51) Int. Cl. G06F 3/033

(52) U.S. Cl. 345/163

(57) ABSTRACT

In embodiments of the present invention, in response to a command to turn off, a wireless mouse transmits a signal to a computer to deactivate, for example by going into a low power mode or by shutting down. A receiver connected to the computer receives the signal and instructs the computer to deactivate in response to the signal from the wireless mouse.

### DESCRIPTION OF THE RELATED ART

Common devices for interacting with a computer are a keyboard and mouse. With a keyboard, a user can enter data and commands by typing on or pressing the keys of the keyboard. With a mouse, the user moves the mouse on a table or desk top to cause corresponding movement of a cursor on the computer's display device. Buttons and other devices, such as a scroll dial, on the mouse can be operated to further interact with the computer, for example, to select items on the display indicated by the cursor, open menus, enter commands, launch programs, or control the display.

A wireless mouse is not physically tethered to the computer, but wirelessly transmits signals to the computer using, for example, a radio frequency (RF) signal.

### BRIEF DESCRIPTION OF THE DRAWINGS

FIG. 1 illustrates a system including a wireless mouse in one example of the present disclosure.

FIG. 2 is a block diagram illustrating a wireless mouse in one example of the present disclosure.

FIG. 3 is a flow chart illustrating a method of receiving user selections of actions to be performed when a wireless mouse is turned off or on, in one example of the present disclosure.

FIG. 4 is a flow chart illustrating a method of deactivating a computer by turning off a wireless mouse, in one example of the present disclosure.

FIG. 5 is a block diagram of a computing device, in one example of the present disclosure.

### DETAILED DESCRIPTION

In embodiments of the present invention, in response to a command to turn off, a wireless mouse transmits a signal to a computer to deactivate. The computer deactivates, for example, by switching into a low power mode or by shutting down. For example, the computer may deactivate by switching into a sleeping state or an off state such as those defined by the Advanced Configuration and Power Interface (ACPI) specification, a standard for power management. For example, the computer may deactivate by switching into connected standby, a low power mode where one or more applications are kept up to date. A receiver connected to the computer receives the signal to deactivate and instructs the computer to deactivate in response to the signal from the wireless mouse. The deactivation state may be selected by the user via mouse driver machine readable instructions.

As used herein, the term “wireless mouse” refers to any device that is not physically connected to a computer, but which sends a mouse signal to the computer that is used to control or interact with the computer. A “mouse signal” is a signal that, for example, indicates the desired movement for an on-screen cursor and conveys other commands or actions input by a user with a mouse. Accordingly, a wireless mouse may include an optical sensor or other encoder that registers movement of the mouse, such as by registering rotation of a ball in the mouse. The ball may be a trackball that is manipulated with a user's fingers or may be a ball that is rolled against a table, desk top or other surface. Alternatively, a wireless mouse may include a trackpad or touch-sensitive screen that senses movement of a user's finger or a stylus sliding over the surface thereof.

As used herein, the term “computer” refers broadly to any device that a user controls or interacts with using a mouse. A computer is often a general purpose computer that can execute a wide variety of applications under the control of a user. Examples of suitable computers include desktop computers, laptop computers, and other personal computers.

Though in the examples below the device that is capable of powering the computer on and off is a wireless mouse, other devices that are powered on and off separate from the computer may be configured to also power the computer on and off. Examples of suitable devices include other computer pointing devices currently available or to be developed, such as a joystick, a touch pad, track ball, or other human interface device (HID) input device.

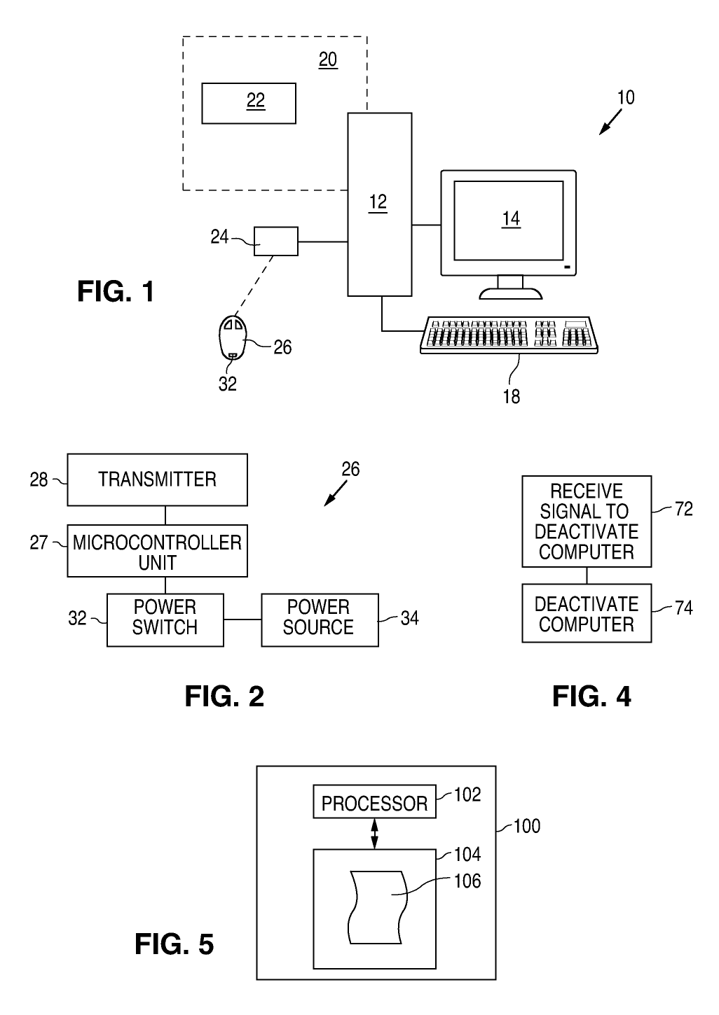

FIG. 1 is a block diagram of a system including a wireless mouse. A computer 10 often includes a display 14, a keyboard 18, and a structure 12, referred to herein as the processor, including a central processing unit, volatile memory, nonvolatile memory, and any other suitable components. A receiver 24 is connected to processor 12. Receiver 24 receives signals from wireless mouse 26. Receiver 24 may be, for example, a radio frequency, infrared, Bluetooth wireless receiver, wifi or another wireless technology. Receiver 24 may be connected to processor 12 by USB or any other suitable connection. A user can interact with and control the computer using, for example, keyboard 18 and/or wireless mouse 26. In response, computer 10 displays a graphical user interface (GUI) generated by the processor 12 on the display 14.

Machine readable instructions 20 are installed on computer 10. Machine readable instructions 20 are a set of computer-readable instructions installed on a computer-readable medium such as, for example, a hard drive of computer 10, and executed by processor 12. Machine readable instructions 20 may include mouse driver machine readable instructions, described below. A user interacts with machine readable instructions 20 via a user interface 22, described below. The mouse 26 can transmit a signal to the computer 10 upon the mouse 26 being turned off using device 32. The device 32 may be a power switch. The signal received by the computer 10 can cause the computer 10 to switch power states, for example turning off the mouse may cause the computer 10 to transition from an operating state to a standby state or an off state.

FIG. 2 is a block diagram of wireless mouse 26. Wireless mouse 26 is controlled by a microcontroller unit 27, which may include a processor, volatile memory, nonvolatile memory, and an input/output control unit. Microcontroller unit 27 receives information from one or more detectors (not shown in FIG. 2) and power switch 32, described below, and directs transmitter 28, described below, to transmit information which may be received by receiver 24.

Wireless mouse 26 includes one or more detectors for detecting user inputs to wireless mouse 26. For example, wireless mouse 26 may include a detector that senses movement of the mouse or movement against a portion of the mouse which is intended by the user to effect corresponding movement of a graphic cursor on display 14. A movement detector may detect, for example, movement of the mouse itself, movement of a trackball on the mouse, movement of a user's finger over a track pad on the mouse, or any other suitable movement. Detectors may also detect when the user has activated a button, dial, or other input device on wireless mouse 26.

Wireless mouse 26 includes a transmitter 28. The inputs detected by the detectors, i.e. movement and/or user clicks, are quantified or rendered as an electronic mouse signal that is transmitted by transmitter 28. Transmitter 28 may be, for example, a radio frequency, infrared, Bluetooth, wifi or another wireless transmitter.

Wireless mouse 26 includes a power source 34, which may be any suitable power source and is often a disposable or rechargeable battery or battery pack. Power source provides power to microcontroller unit 27, transmitter 28, detectors, and any other device that is part of wireless mouse 26.

Wireless mouse 26 also includes a device 32, for example a power switch, which turns wireless mouse 26 on and off. When wireless mouse 26 is not in use, a user may turn off wireless mouse 26 in order to reduce power consumption. Often the user is turning off wireless mouse 26 because the user is finished with computer 10 as well. Wireless mouse 26 and machine readable instructions 20 may be configured such that turning off wireless mouse 26 also deactivates computer 10. For example, turning off wireless mouse 26 may turn off computer 10, or put computer 10 into a low power state. In the case of a mechanical power switch 32, the switch may be arranged such that the switch informs the microcontroller unit 27 to cause the transmitter 28 to send a command to deactivate computer 10 then power down wireless mouse 26. One example of a suitable mechanical switch is the three pole slide switch described below. In the case of a momentary power switch 32, when the momentary power switch receives an “off” command, microcontroller unit 27 instructs transmitter 28 to send a command to deactivate computer 10, then wireless mouse 26 turns off. One example of a suitable electronic switch is the push button switch described below.

Power switch 32 may be, for example, a mechanical switch with a third switch state in addition to the on and off states. The third switch state causes transmitter 28 to send a command to deactivate computer 10. On a three pole, slide switch, the third switch state may be between the on and off positions such that when a user slides the switch from on to off, the third switch state is activated before the switch is slid to the off state.

Power switch 32 may be, for example, a push button switch. When the wireless mouse 26 is on and the user pushes the push button power switch 32, microcontroller unit 27 instructs transmitter 28 to send a command to deactivate computer 10.

The command to deactivate computer 10 is received by receiver 24 and transmitted to and interpreted by processor 12. Machine readable instructions 106, illustrated in FIG. 5, are stored in a non-transitory computer readable medium 104 on computer 100. Machine readable instructions 106, e.g., a mouse driver, receive the signal from receiver 24 of FIG. 1 and issue a command to processor 102 for the computer 100 to deactivate. The computer may deactivate by going into a low power or power-saving mode such as connected standby, standby mode, hibernation, or full shutdown. Alternatively, the computer may deactivate by locking.

Standby mode may refer to a condition where, for example, the display 14 of FIG. 1 and hard drive are inactive, but data and running applications are still maintained in volatile memory, such as random access memory. Connected standby may refer to a standby mode where one or more applications are kept up to date. Hibernation may refer to a condition where the state of all running applications is saved to the hard drive so that the application(s) can later be rejoined at the point of hibernation; the computer is then shut down. Full shut down may refer to a condition where all running applications are terminated and the computer is then shut down.

“Locking” or “locking up” the computer may refer to a condition where the computer displays a masking screen to conceal the current output of the computer on the display 14 so that a passerby cannot see what the user of the computer is working on. Additionally, a locked computer may refuse to accept any entry or respond to any commands until a password or other user identifier is input to unlock the computer.

After the computer is deactivated, the computer may be activated by, for example, unlocking the computer, with or without entry of a password or user identification, or bringing the computer out of a power-saving mode, for example by turning the computer on.

Computer 10 may be put into a deactivation state where receiver 24 of FIG. 1 can still receive signals from wireless mouse 26 and processor 12 can still receive signals from receive 24. For example, receiver 24 may be connected to a USB port on computer 10. In some low power states, USB ports, wifi or Bluetooth may remain active such that receiver 24 can still receive signals from wireless mouse 26 and processor 12 may be in a mode where it can still receive signals from receiver 24. In one example if the mouse is connected to the computer through a USB port dongle, wifi, Bluetooth or other wireless module, that communication module may stay on to wait for a signal from the mouse to wake up. The communication module may turn off after a time period has passed for example if a Bluetooth mouse causes the computer to enter an off state when the mouse was turned off the Bluetooth module of the computer may for example remain active for 12 hours and then turn off to save battery. When computer 10 is put into a deactivation state where receiver 24 can still receive signals, wireless mouse 26 and machine readable instructions 20 may be configured such that turning on wireless mouse 26 also activates computer 10. Turning on wireless mouse 26 after computer 10 has been put in a low power state may bring computer 10 out of the low power state. Turning on wireless mouse 26 after computer 10 has been locked may unlock computer 10, or cause processor to display a screen prompting the user to enter a password or other user identification to unlock computer 10.

The action taken by computer 10 in response to the signal received by receiver 24 to deactivate may be selected by the user in advance via machine readable instructions 20. User interface 22 of FIG. 1 allows the user to dictate what deactivation mode is initiated in response to turning off wireless mouse 26. When the user turns off wireless mouse 26, the computer is deactivated without the user having to take any additional action to deactivate the computer, such as turning off the computer.

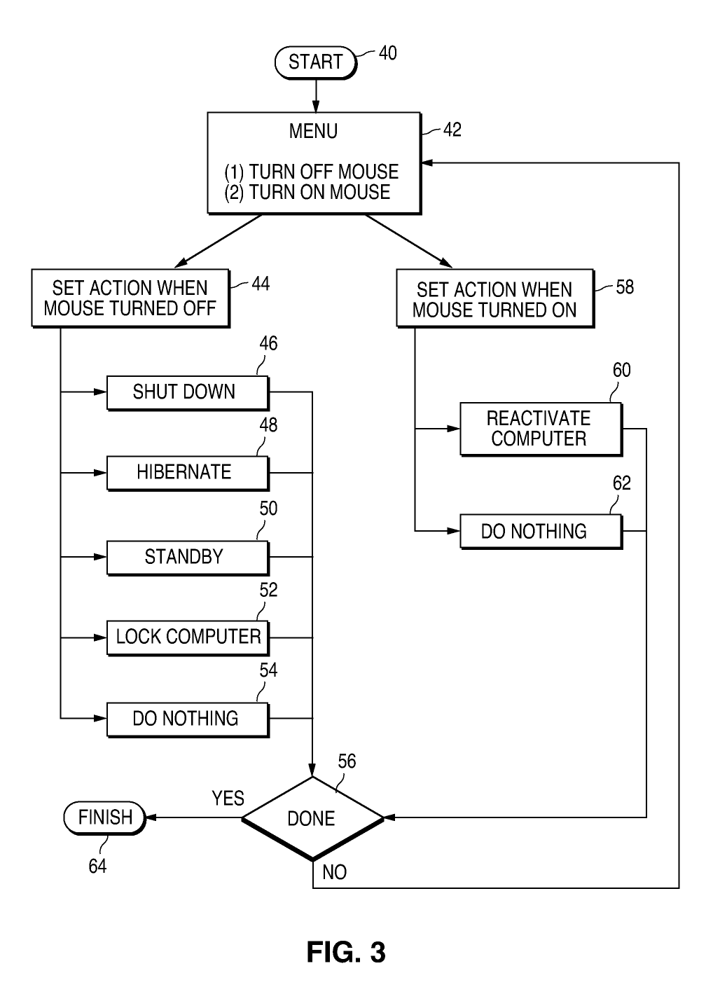

FIG. 3 is a flow chart illustrating the operation of machine readable instructions used by a user to select the action taken when wireless mouse 26 is turned off or on. The action to be taken when wireless mouse 26 is turned off or on may be selected initially, for example, when wireless mouse 26 is set up. The operation illustrated in FIG. 3 takes place when the user wishes to change the action taken when wireless mouse 26 is turned off or on. The operation illustrated in FIG. 3 may not take place every time wireless mouse 26 is turned off or on. A default action to be taken when wireless mouse 26 is turned off or on may be included in machine readable instructions 106 illustrated in FIG. 5, such that the user need not go through the operation illustrated in FIG. 3 the user wishes for the default action to be taken when wireless mouse 26 is turned off or on.

The process illustrated in FIG. 3 begins at block 40. The user interface 22 of FIG. 1 may include a menu 42. Menu 42 allows the user to specify the action to be taken when the wireless mouse 26 is turned off or on.

If the user selects option (1) from menu 42, the user may then specify the action taken 44 when the mouse is turned off. As described above, a user often turns off wireless mouse 26 when the user is finished with a session with computer 10, thus the computer can be deactivated. By automatically deactivating the computer, time and effort are spared for the user who would otherwise have to manually deactivate the computer. Several states of deactivation are possible. The computer can be fully shut down 46, sent into hibernation 48, placed on standby 50, or locked 52, as described above. Alternatively, the user may not wish for the computer to be deactivated when the wireless mouse is turned off. Thus, the user can also select “do nothing” 54 as the action to be taken when the wireless mouse is turned off. After making a selection, at decision 56 the user returns to menu 42 or terminates the user interface 64.

From menu 42, the user can select option (2) and specify the action to be taken when wireless mouse 26 is turned on. Often, the user will want the computer to be automatically reactivated when wireless mouse 26 is turned on. The user can specify that the computer be activated 60 when wireless mouse 26 is turned on and computer 10 is in a deactivation state where computer 10 can still receive signals from wireless mouse 26. Alternatively, the user may not wish for the computer to take any action when wireless mouse 26 is turned on, even if the computer was automatically deactivated when wireless mouse 26 was turned off. Thus, the user can specify that no action 62 is to be taken automatically when wireless mouse 26 is turned on.

FIG. 4 is a flow chart illustrating a method of deactivating a computer. In block 72, processor 12 receives a signal from receiver 24 to deactivate computer 10. Receiver 24 receives the signal from transmitter 28 of wireless mouse 26. In response to the signal received in block 72, in block 74, processor 12 deactivates computer 10. For example, the processor may place the computer in a default deactivation state or in a deactivation state received for example as illustrated in FIG. 3.

If the computer is deactivated before wireless mouse 26 is turned off, when wireless mouse 26 is turned off, transmitter 28 sends a signal to receiver 24 to deactivate computer 10. The processor takes no action in response to the signal since the computer 10 is already deactivated. When wireless mouse 26 is turned back on, if computer 10 is in a deactivation state where receiver 24 can receive signals from wireless mouse 26, receiver 24 may activate computer 10.

Deactivating and activating a computer automatically by turning a wireless mouse off and on spares the user the time and effort required to separately deactivate the computer. In addition, using the wireless mouse to deactivate the computer may reduce power consumption because the computer is deactivated every time the wireless mouse is deactivated—the user does not have to remember to separately deactivate the computer.

The above detailed descriptions are provided to illustrate specific embodiments of the present invention and are not intended to be limiting. Numerous modifications and variations within the scope of the present invention are possible. The present invention is defined by the appended claims.

What is being claimed is:

1. A method comprising:
receiving, using a processor, a signal from a wireless mouse through a wireless receiver to deactivate a computer; and
deactivating the computer in response to the signal.

2. The method of claim 1 wherein the signal is generated by a device to turn a wireless mouse off and on in response to a user input.

3. The method of claim 1 wherein the signal indicates a wireless mouse is turned off.

4. The method of claim 1 wherein deactivating the computer comprises putting the computer into a low power consumption mode.

5. The method of claim 1 further comprising receiving a selection from a user of a deactivation state to put the computer in when the deactivation signal is received from the wireless mouse.

6. The method of claim 1 wherein the signal is a first signal, the method further comprising:
receiving, using a processor, a second signal from a wireless mouse through a wireless receiver to activate the computer; and
activating the computer in response to the second signal.

7. The method of claim 1 wherein deactivating the computer comprises shutting down the computer.

8. The method of claim 1 further comprising:
a wireless mouse receiving a command to turn off; and
in response to the command to turn off, the wireless mouse transmitting the signal to deactivate the computer.

9. A method comprising:
receiving, using a processor, a selection of a deactivation state to put a computer in when a wireless mouse is turned off;
receiving a signal from a wireless receiver to deactivate the computer, wherein the signal is generated by a device to turn a wireless mouse off and on in response to a user input; and
deactivating the computer in response to the signal.

10. The method of claim 9 wherein the signal is a first signal, the method further comprising:
receiving a second signal from a wireless receiver to activate the computer, wherein the signal is generated by a device to turn a wireless mouse off and on in response to a user input; and
activating the computer in response to the second signal.

11. The method of claim 9 wherein deactivating the computer comprises shutting down the computer.

12. A structure comprising:
a wireless mouse comprising:
a transmitter; and
a device to turn the wireless mouse off and on; and
a microcontroller unit to cause the transmitter to transmit a signal to deactivate a computer in response to an input to the device turning the wireless mouse off.

13. The structure of claim 12 wherein:
the device to turn the wireless mouse off and on comprises a three pole slide switch;
a first pole of the three pole switch is to turn the wireless mouse on;
a second pole of the three pole switch is to turn the wireless mouse off; and
a third pole of the three pole switch is to transmit a signal to deactivate a computer.

14. The structure of claim 12 further comprising a wireless receiver to connect to a computer.
